(19) United States
(12) Patent Application Publication
(10) Pub. No.: US 2026/0051678 A1
(43) Pub. Date: Feb. 19, 2026

(54) ELECTRICAL RECEPTACLE CONNECTOR

(71) Applicant: VITECK CO., LTD., Taoyuan City (TW)

(72) Inventor: Yu-Ching Chu, Taoyuan City (TW)

(73) Assignee: VITECK CO., LTD., Taoyuan City (TW)

(21) Appl. No.: 18/902,871

(22) Filed: Sep. 30, 2024

(30) Foreign Application Priority Data
Aug. 13, 2024 (TW) 113130239

(51) Int. Cl. H01R 12/72; H01R 13/518

(52) U.S. Cl. CPC H01R 12/721; H01R 13/518

(57) ABSTRACT

An electrical receptacle connector includes a circuit board, an insulation body, and two side metal arms. The circuit board has a board fringe connection portion, an output portion, and an intermediate portion. The board fringe connection portion includes a plurality of trace tails. A metal strip is electrically fixed on each trace tail. The insulation body encapsulates the intermediate portion. The insulation body also covers the board fringe connection portion with exposing the metal strips. The two side metal arms are disposed close to two opposite sides of the board fringe connection portion. The two side metal arms both are embedded in the insulation body but are at least partially exposed from the insulation body.

### BACKGROUND OF THE INVENTION

### 1. Field of the Invention

The present invention relates to an electrical connector, and more particularly to an electrical receptacle connector with a circuit board.

### 2. Description of the Prior Art

Electrical connectors are often used to connect two electronic devices. Generally, electrical connectors mainly include an insulation body and a plurality of independent metal terminals fixed through the insulation body. The more contacts an electrical connector has, the more metal terminals it needs, causing it difficult to assemble the electrical connector. When the contact pitch becomes smaller, the difficulty of structural design and assembly increases. Furthermore, it is not easy for electrical connectors with many contacts to be directly connected to circuit boards or cables through the metal terminals.

### SUMMARY OF THE INVENTION

In view of the problems in the prior art, an objective of the invention is to provide an electrical receptacle connector, which uses a circuit board as the electrical connection between the input and output of the electrical receptacle connector.

An electrical receptacle connector of an embodiment according to the invention includes a circuit board, an insulation body, a left side metal arm, and a right side metal arm. The circuit board has a board fringe connection portion, an output portion, and an intermediate portion. The board fringe connection portion and the output portion are on two sides of the intermediate portion. The board fringe connection portion has a front side edge, a left side edge, and a right side edge. The board fringe connection portion includes a plurality of trace tails. A metal strip is electrically fixed on each trace tail. The insulation body encapsulates the intermediate portion. The insulation body also covers the board fringe connection portion with exposing the metal strips. The left side metal arm is disposed close to the left side edge. The left side metal arm is embedded into the insulation body but is at least partially exposed from the insulation body. The right side metal arm is disposed close to the right side edge. The right side metal arm is embedded into the insulation body but is at least partially exposed from the insulation body. Therein, the board fringe connection portion serves as a plug-in connection port of the electrical receptacle connector to connect with a mating electrical connector. Thereby, through mature circuit board manufacturing technology, the internal electrical connection structure of the electrical receptacle connector can be simplified, reducing the difficulty of structural design and assembly of the electrical receptacle connector. Furthermore, the output portion of the circuit board also facilitates interface design for electrical connection with external connection components. For example, a connector is electrically fixed on the output portion; alternatively, a flat cable is directly electrically fixed on the output portion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing an electrical receptacle connector according to an embodiment.

FIG. 2 is a schematic diagram showing the electrical receptacle connector in FIG. 1 in another viewpoint.

FIG. 3 is a partially-exploded view of the electrical receptacle connector in FIG. 1.

FIG. 4 is a schematic diagram showing the electrical receptacle connector in FIG. 3 in another viewpoint.

FIG. 5 is an exploded view of a circuit board of the electrical receptacle connector and related components.

FIG. 6 is a schematic diagram showing the circuit board and the related components after they are combined.

FIG. 7 is a schematic diagram showing the metal casing fixed on the insulation body in FIG. 3.

FIG. 8 is a schematic diagram showing a variant of the electrical receptacle connector in FIG. 1.

FIG. 9 is an exploded view of another variant of the electrical receptacle connector in FIG. 1.

FIG. 10 is a schematic diagram showing the electrical receptacle connector in FIG. 9 of which the output portion is inserted into another extern electrical connector.

FIG. 11 is a schematic diagram showing the metal frame in FIG. 6 that is replaced with a variant.

### DETAILED DESCRIPTION

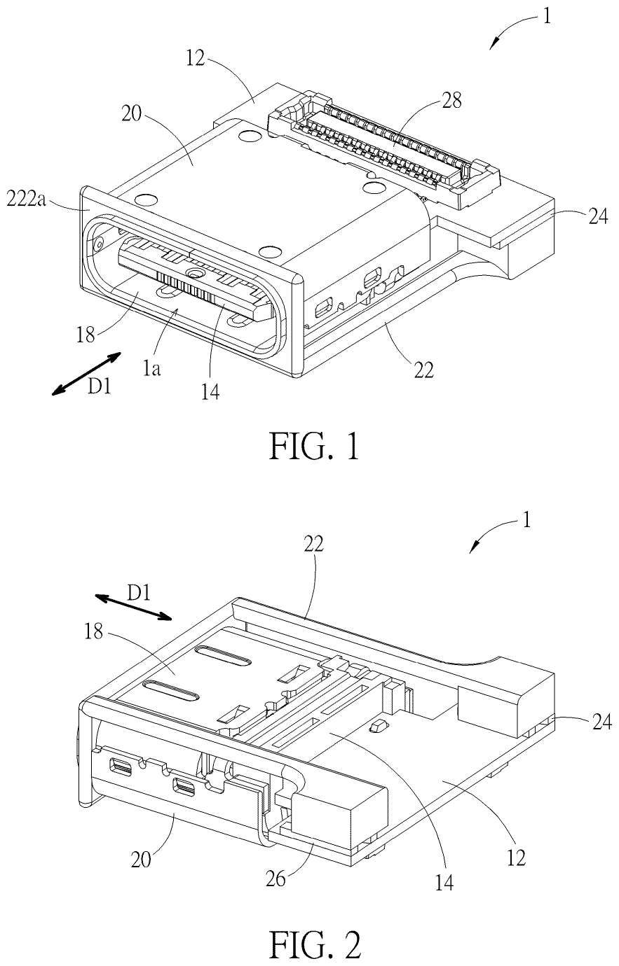

Please refer to FIG. 1 to FIG. 4. An electrical receptacle connector 1 according to an embodiment includes a circuit board 12, an insulation body 14, a metal frame 16, a metal casing 18, a metal shell 20, a light-guiding structure 22, a first light source 24, and a second light source 26. The circuit board 12 is, for example but not limited to, a printed circuit board. The insulation body 14 is fixed on the circuit board 12. The metal frame 16 is embedded into the insulation body 14 and is partially exposed from the insulation body 14. The metal casing 18 is fixed on the insulation body 14. The metal shell 20 is detachably connected to the outside of the metal casing 18. The first light source 24 and the second light source 26 are electrically fixed on the circuit board 12. The light-guiding structure 22 is disposed corresponding to the first light source 24 and the second light source 26 to guide the light emitted by the first light source 24 and the second light source 26 to the front side of the electrical receptacle connector 1 to provide optical indication of the connector insertion operation. The electrical receptacle connector 1 provides a connection port 1a. A mating electrical connector can be inserted into the connection port 1a in a plug-in connection direction D1 (indicated by a dual-headed arrow in the figures) or pulled out from the connection port 1a, so as to achieve connection or disconnection of the electrical receptacle connector 1.

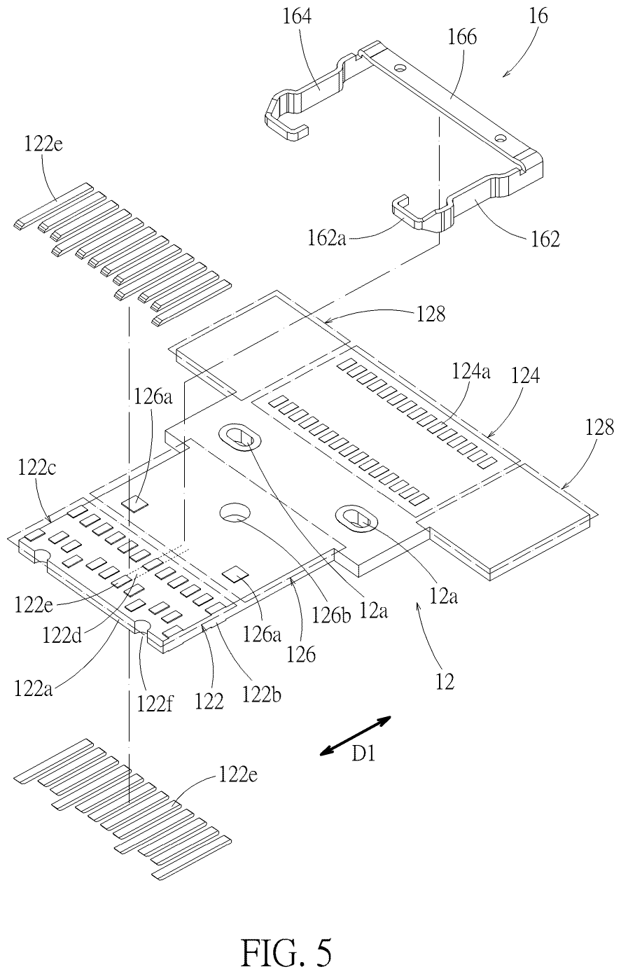

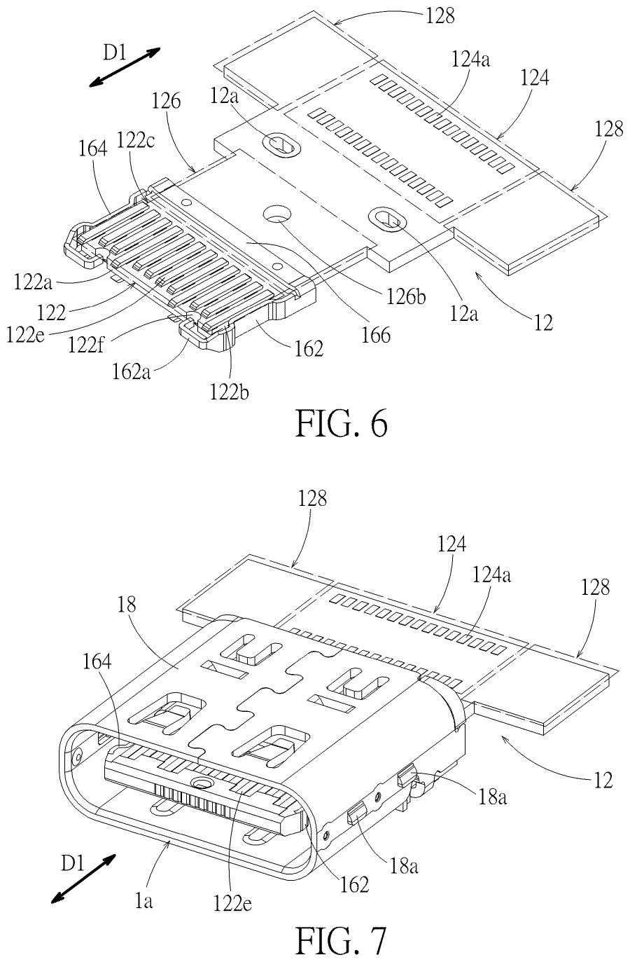

Please refer to FIG. 5 and FIG. 6, which show an exploded view of the circuit board 12 and related components and a schematic diagram showing the circuit board 12 combined with the related components in FIG. 5. In the embodiment, the circuit board 12 is a printed circuit board with an overall T-shaped outline. FIG. 5 shows the upper surface of the circuit board 12. The circuit board 12 has a board fringe connection portion 122, an output portion 124, and an intermediate portion 126; these three are shown with frames in chain lines in the figures to indicate their ranges. The board fringe connection portion 122 is on the front side of the circuit board 12; the output portion 124 is on the rear side of the circuit board 12; the intermediate portion 126 is between the board fringe connection portion 126 and the output portion 124. The circuit board 12 also has two wing portions 128 (the scopes of which are also indicated by frame in chain lines in the figures) and are on two sides of the output portion 124 in a direction perpendicular to the plug-in connection direction D1. The board fringe connection portion 122 has a front side edge 122a, a left side edge 122b, and a right side edge 122c. The board fringe connection portion 122 includes a plurality of trace tails 122d (one of which is selected for labeling and is shown in dashed lines in FIG. 5) on both its upper and lower surfaces and between the left side edge 122b and the right side edge 122c. Furthermore, in the embodiment, the trace tails 122d on the upper and lower surfaces of the board fringe connection portion 122 are arranged symmetrically, so no further description will be described in addition.

In the embodiment, a metal strip 122e is electrically fixed on each trace tail 122d, for example but not limited to, by soldering (in which the trace tail 122d is provided with two solder pads for soldering the corresponding metal strip 122e, but it is not limited thereto in practice). The metal strip 122e is strip-shaped and extends parallel to the plug-in connection direction D1. Among them, four metal strips 122e are relatively long, and after soldered to the corresponding trace tails 122d (as shown by FIG. 6), they will still protrude from the front side edge 122a in the plug-in connection direction D1; however, it is not limited thereto in practice. In principle, the metal strips 122e serve as the contacts of the connection interface of the electrical receptacle connector 1 for connecting with the mating electrical connector, so the length and position of the metal strips 122e are determined by the design of the connection interface. Furthermore, the metal strips 122e have better wear resistance than the trace tails 122d, so the metal strips 122e can extend the service life of the electrical receptacle connector 1. In addition, the metal strips 122e does not use an elastic structure to contact the contacts of the mating electrical connector, so there will be no problem of poor contact due to elastic fatigue contacts of a general connector that uses elastic structures as contacts.

The metal frame 16 as a whole is n-shaped. The metal frame 16 includes a left side metal arm 162, a right side metal arm 164, and a connecting arm 166. The connecting arm 166 connects the left side metal arm 162 and the right side metal arm 164. The metal frame 16 is fixedly disposed. Therein, the connecting arm 166 is fixed on the circuit board 12 (or the intermediate portion 126 thereof), for example but not limited to, by soldering on the solder pads 126a of the circuit board 12 (in this example, it is practicable that the metal frame 16 is electrically fixed on the circuit board 12; for example the solder pad 126a is connected to the circuit on the circuit board 12). The left side metal arm 162 is disposed close to the left side edge 122b of the board fringe connection portion 122. The right side metal arm 164 is disposed close to the right side edge 122c of the board fringe connection portion 122. In the embodiment, neither the left side metal arm 162 nor the right side metal arm 164 directly contacts the circuit board 12, but it is not limited thereto in practice.

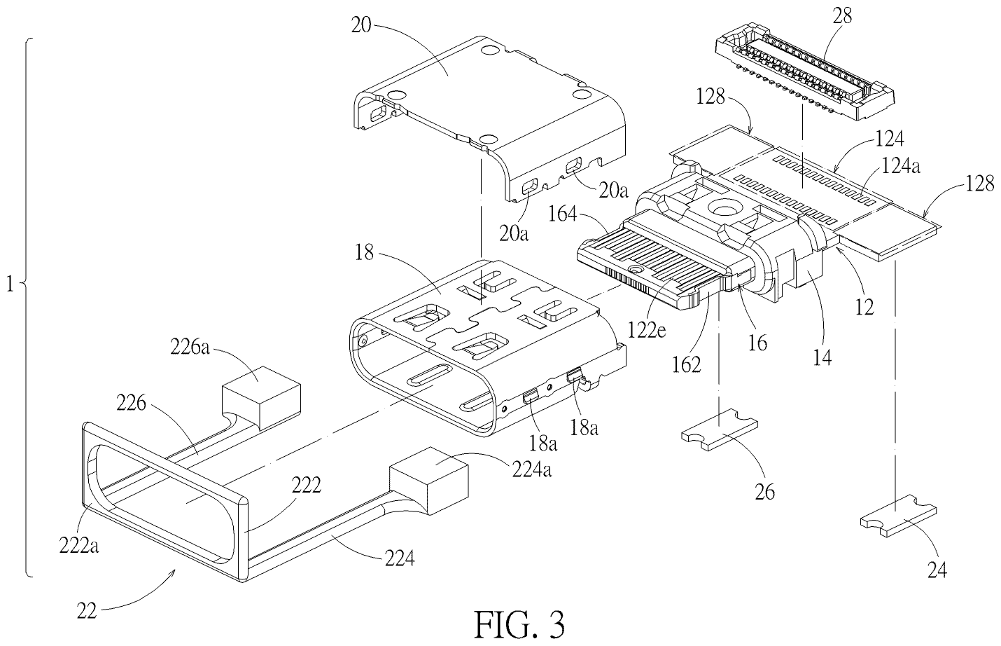

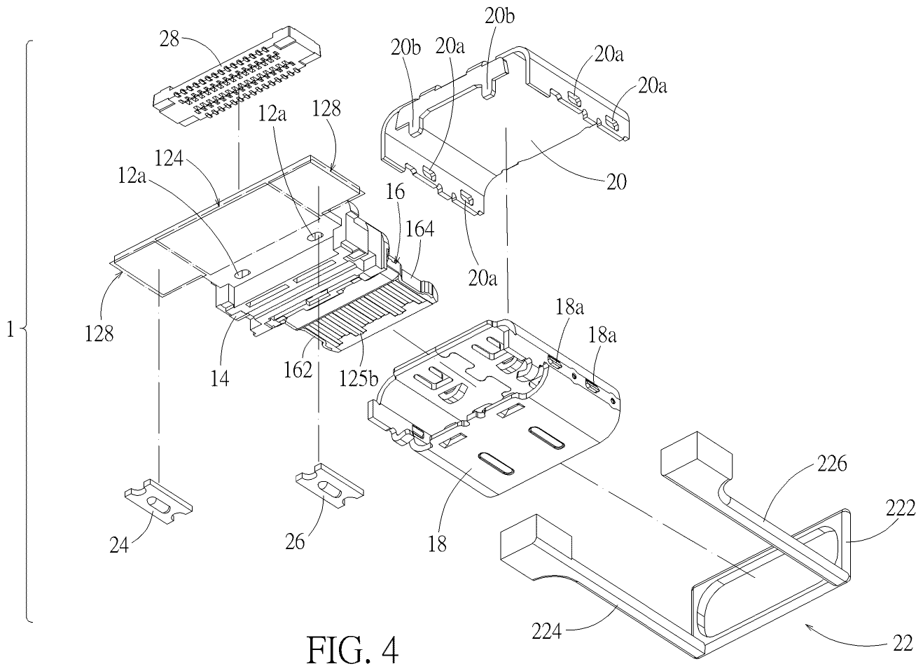

Please refer to FIG. 3, FIG. 4 and FIG. 6. The insulation body 14 encapsulates the intermediate portion 126 of the circuit board 12. The insulation body 14 also covers the board fringe connection portion 122 with exposing the upper surfaces of the metal strips 122e (used to contact the contacts of the mating electrical connector). In practice, the insulation body 14 can be formed on the circuit board 12 through, for example but not limited to, insertion molding. Furthermore, the insulation body 14 encapsulates the connecting arm 166 of the metal frame 16 and also covers the left side metal arm 162 and the right side metal arm 164, so that the left side metal arm 162 and the right side metal arm 164 both are at least partially exposed from the insulation body 14. In addition to increasing the strength of the overall structure of the electrical receptacle connector 1, the insulation body 14 can also improve the fixation stability of the metal frame 16 and metal strip 122e on the circuit board 12. Furthermore, in the embodiment, the insulation body 14 covers the front side edge 122a of the board fringe connection portion 122, which also avoids the problem of abrasion of the circuit board 12 due to the insertion of the mating electrical connector into the electrical receptacle connector 1. In addition, the intermediate portion 126 has a through hole 126b (referring to FIG. 5). The insulation body 14 fills up the through hole 126b, which helps the portions of the insulation body 14 above and below the circuit board 12 to be connected with each other and increases the fixation of the insulation body 14 on the circuit board 12.

In addition, in the embodiment, in the metal frame 16, the left side metal arm 162 is a cantilever structure relative to the connecting arm 166. The front side edge 122a of the board fringe connection portion 122 has a notch 122f. The left side metal arm 162 has a bending end portion 162a (that is, its free end is bent), which is close to the front side edge 122a and whose distal end points toward the notch 122f. The bending end portion 162a is at least partially exposed from the insulation body 14. On the other hand, the bending end portion 162a is bent relative to the corner where the front side edge 122a and the left side edge 122b are connected. This structural configuration has the effect of protecting the corner, also improves the strength of the insertion body 14 here, and improves the insertion reliability of the mating electrical connector. In addition, the right side metal arm 164 also has the same structure, which will not be repeated. Furthermore, in the embodiment, the left side metal arm 162 and the right side metal arm 164 also participate in the mechanical and/or electrical connection between the electrical receptacle connector 1 and the mating electrical connector.

Please refer to FIG. 3 and FIG. 5. In the embodiment, the output portion 124 includes a plurality of trace contacts 124a (one of which is selected for labeling in FIG. 5). The electrical receptacle connector 1 also includes a connector 28 electrically fixed on the trace contacts 124a of the output portion 124 (also referring to FIG. 1). The connector 28 can be connected to another external connector (such as but not limited to a connector on a circuit board or a connector connected to a cable).

Please refer to FIG. 3, FIG. 4 and FIG. 7; therein, FIG. 7 is a schematic diagram showing the metal casing 18 fixed on the insulation body 14 in FIG. 3. In the embodiment, the metal casing 18 as a whole is in the shape of a cylinder and is sleeved on the insulation body 14. The metal casing 18 surrounds the board fringe connection portion 122. The metal casing 18 and the board fringe connection portion 122 (and the insulation body 14 thereon) jointly form the connection port 1a (also referring to FIG. 1).

Please refer to FIG. 1 to FIG. 4. The metal casing 18 has a hook 18a on both left and right sides. The metal shell 20 as a whole has a semi-cylindrical shape with an n-shaped cross-section. The metal shell 20 has a recess 20a on both left and right sides. The metal shell 20 is detachably connected to the metal casing 18 by snapping the hooks 18a into the recesses 20a. Furthermore, in the embodiment, the metal shell 20 is electrically fixed on the circuit board 12. Therein, the metal shell 20 has two supporting feet 20b. The circuit board 12 has two through holes 12a. The supporting feet 20b are inserted into the through holes 12a and fixed by soldering. The metal shell 20 roughly covers the rear side of the insulation body 14 protruding from the upper surface of the circuit board 12. In practical applications, the metal shell 20 can be used to fix the electrical receptacle connector 1 to an external structure (such as but not limited to a computer case).

Furthermore, the first light source 24 and the second light source 26 are electrically fixed on the two wing portions 128 (the lower surface of the circuit board 12), respectively, so in the direction perpendicular to the plug-in connection direction D1, the first light source 24 and the second light source 26 are located on two sides of the output portion 124 (or the connector 28), and in the plug-in connection direction D1, the first and second light sources 24 and 26 and the board fringe connection portion 122 are located on both sides of the intermediate portion 126, respectively (also referring to FIG. 5).

The light-guiding structure 22 includes an annular portion 222, a first conduction portion 224, and a second conduction portion 226. The first conduction portion 224 and the second conduction portion 226 are connected to the annular portion 222 oppositely with respect to the insertion direction D1. The annular portion 222 is sleeved on the metal casing 18 and close to the front side edge 122a of the board fringe connection portion 122, so that the light-emitting surface 222a of the annular portion 222 is exposed from the front side of the electrical receptacle connector 1 and surrounds the connection port 1a (or the front side edge 122a is located on the inner side of the annular portion 222 in the plug-in connection direction D1). The first conduction portion 224 and the second conduction portion 226 are on two opposite sides of the annular portion 222 and also on two opposite sides of the metal casing 18 (or the metal shell 20). The first conduction portion 224 as a whole is in the shape of a straight rod. An end of the first conduction portion 224 is connected to the annular portion 222, and the other end of the first conduction portion 224 has a first light incident surface 224a. The first light incident surface 224a faces the first light source 24 (or the light-emitting surface thereof). Thereby, light emitted by the first light source 24 can enter the first conduction portion 224 from the first light incident surface 224a, be guided to the annular portion 222 through the first conduction portion 224, and finally exit the light-guiding structure 22 through the light-emitting surface 222a of the annular portion 222. Similarly, the second conduction portion 226 as a whole is also in the shape of a straight rod. An end of the second conduction portion 226 is connected to the annular portion 222, and the other end of the second conduction portion 226 has a second light incident surface 226a. The second light incident surface 226a faces the second light source 26 (or the light-emitting surface thereof). Thereby, light emitted by the second light source 26 can enter the second conduction portion 226 from the second light incident surface 226a, be guided to the annular portion 222 through the second conduction portion 226, and finally exit the light-guiding structure 22 through the light-emitting surface 222a of the annular portion 222. The light emitted by the light-emitting surface 222a can provide an optical indication of the connector insertion operation adjacent to the connection port 1a. In practice, the first light source 24 and the second light source 26 are not limited to emit light of the same color, and are not limited to emit light at the same time.

As described above, the output portion 124 of the electrical receptacle connector 1 is connected to an external connector through a connector 28 fixed thereon. However, in practice, the output portion 124 of the electrical receptacle connector 1 can also be connected to external connection components in other ways. For example, please refer to FIG. 8. An electrical receptacle connector 1′is a variant of the electrical receptacle connector 1. In principle, the electrical receptacle connector 1′follows the reference numbers of the electrical receptacle connector 1. Therefore, for other descriptions about the electrical receptacle connector 1′, please refer to the relevant descriptions above, which will not be repeated in addition. Compared with the electrical socket connector 1, the electrical socket connector 1′does not have a connector (such as the aforementioned connector 28) on the output portion 124, but a flat cable 30 is electrically fixed on the output portion 124 (for example, by soldering; furthermore, the connection between the flat cable 30 and the output portion 124 in the figure is for illustration only, and the specific connection depends on the actual product and will not be described in addition). The electrical receptacle connector 1′ is connected to external connection components through flat cable 30. In practice, the other end of the flat cable 30 can also be provided with a connector, which will not be described further in addition.

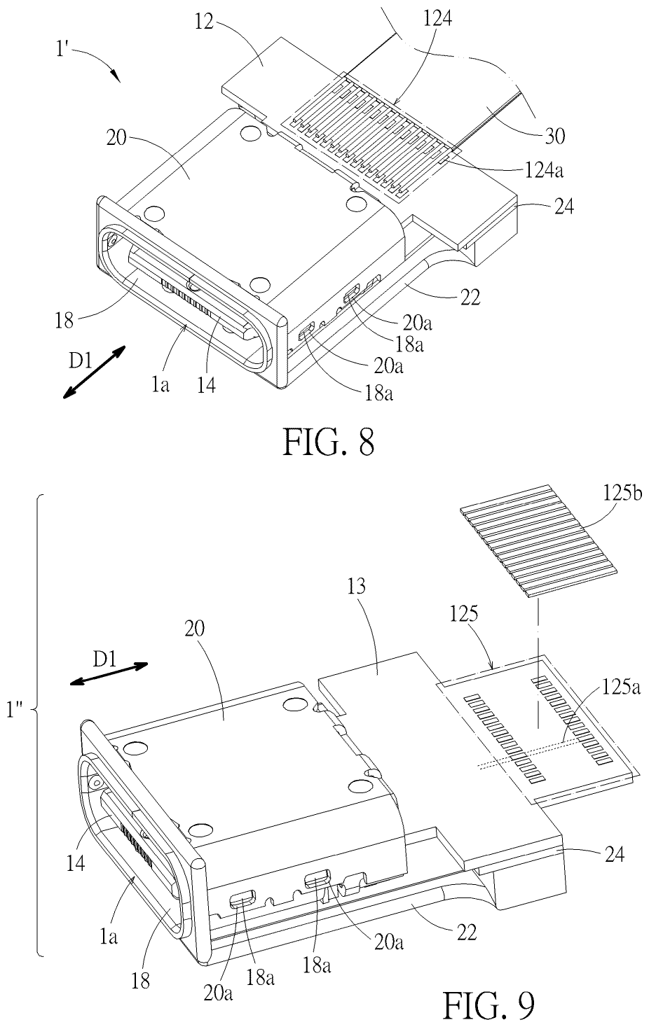

For another example, please refer to FIG. 9 and FIG. 10. An electrical receptacle connector 1″ is another variant of the electrical receptacle connector 1. In principle, the electrical receptacle connector 1″ follows the reference numbers of the electrical receptacle connector 1. Therefore, for other descriptions about the electrical receptacle connector 1″, please refer to the relevant descriptions above, which will not be repeated in addition. Compared with the electrical socket connector 1, the electrical socket connector 1″ does not have a connector (such as the aforementioned connector 28) on the output portion 124, but adopts a similar design to the board fringe connection portion 122. Furthermore, the outline of the circuit board 13 of the electrical receptacle connector 1″ is modified accordingly, and is different from the outline of the circuit board 12 of the electrical receptacle connector 1. In the electrical receptacle connector 1″, the output portion 125 is located at a board fringe of the circuit board 13 and includes a plurality of trace tails 125a (one of which is selected for labeling and is shown in dashed lines in FIG. 9). A metal strip 125b is electrically fixed on each trace tail 125a, for example but not limited to, by soldering (in which the trace tail 125a is provided with two solder pads for soldering the corresponding metal strip 125b, but it is not limited thereto in practice). The metal strip 125b is strip-shaped and extends parallel to the plug-in connection direction D1. In logic, the output portion 125 with the metal strips 125b is equivalent to a board edge connector. The electrical receptacle connector 1″ is connected to an external connection component through the board edge connector, for example by inserting the board edge connector into the connection port 4a of an external electrical receptacle connector 4 (such as but not limited to a connector on a circuit board or a connector connected to a cable), as shown by FIG. 10 (in which the partial outline of the external electrical receptacle connector 4 is shown in dashed lines). In addition, in the electrical receptacle connector 1″, the trace tails 125a of the output portion 125 are disposed only on the same surface of the output portion 125; however, it is not limited thereto in practice. For example, the upper and lower surfaces of the output portion 125 are provided with the trace tails 125a and the metal strips 125b, which will not be described in addition.

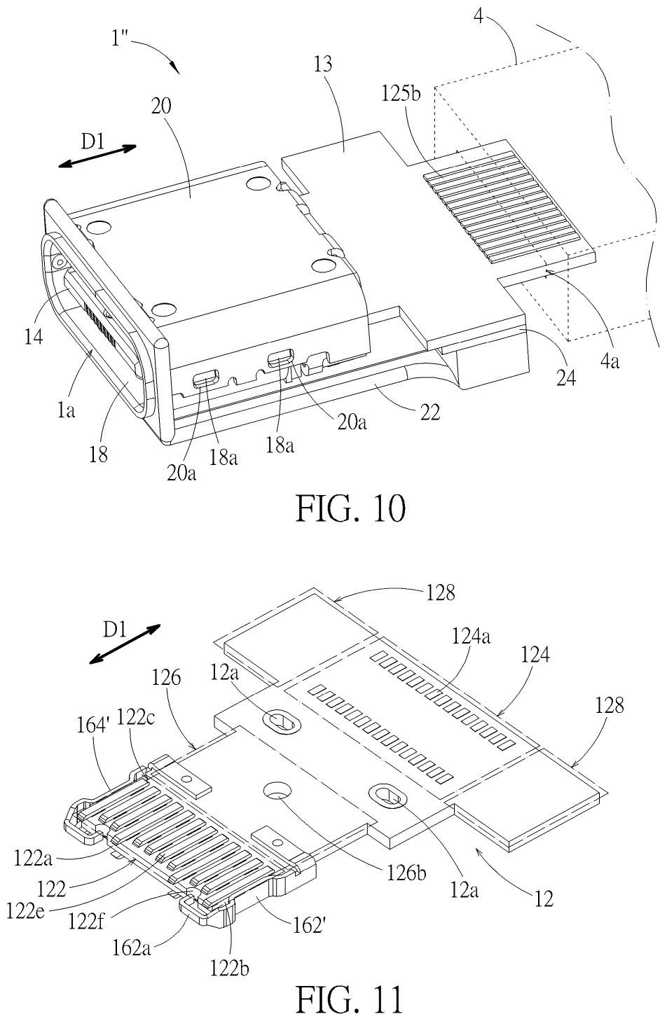

In addition, in the electrical receptacle connector 1, the left side metal arm 162 and the right side metal arm 164 are connected by the connecting arm 166 to form a single structural member (i.e., the metal frame 16); however, it is not limited thereto in practice. Please refer to FIG. 11, which illustrates roughly the same structural configuration as FIG. 6. The difference is that the left side metal arm 162′and the right side metal arm 164′in FIG. 11 are not directly connected to each other, and can be logically regarded as the metal frame 16 without the connecting arm 166. In this example, the left side metal arm 162′and the right side metal arm 164′both are electrically fixed on the circuit board 12. The left side metal arm 162′and the right side metal arm 164′both are embedded in to the insulation body 14 but at least partially exposed from the insulation body 14. After the insulation body 14 is formed on the circuit board 12, its appearance is equivalent to that shown in FIG. 3, so it is not shown by other figures.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrical receptacle connector, comprising:
a circuit board, the circuit board having a board fringe connection portion, an output portion, and an intermediate portion, the board fringe connection portion and the output portion being on two sides of the intermediate portion, the board fringe connection portion having a front side edge, a left side edge, and a right side edge, the board fringe connection portion comprising a plurality of trace tails, a metal strip being electrically fixed on each trace tail;
an insulation body, the insulation body encapsulating the intermediate portion, the insulation body also covering the board fringe connection portion with exposing the metal strips;
a left side metal arm, the left side metal arm being disposed close to the left side edge, the left side metal arm being embedded into the insulation body but at least partially exposed from the insulation body; and
a right side metal arm, the right side metal arm being disposed close to the right side edge, the right side metal arm being embedded into the insulation body but at least partially exposed from the insulation body.

2. The electrical receptacle connector according to claim 1, further comprising a connector, wherein the connector is electrically fixed on the output portion.

3. The electrical receptacle connector according to claim 1, further comprising a flat cable, wherein the flat cable is electrically fixed on the output portion.

4. The electrical receptacle connector according to claim 1, further comprising a metal casing, wherein the metal casing is fixed on the insulation body and surrounds the board fringe connection portion.

5. The electrical receptacle connector according to claim 4, further comprising a metal shell, wherein the metal shell is detachably connected to an outside of the metal shell.

6. The electrical receptacle connector according to claim 5, wherein the metal shell is electrically fixed on the circuit board.

7. The electrical receptacle connector according to claim 1, wherein the left side metal arm has a bending end portion, and the bending end portion is disposed close to the front side edge and is at least partially exposed from the insulation body.

8. The electrical receptacle connector according to claim 1, wherein the left side metal arm and the right side metal arm both are electrically fixed on the circuit board.

9. The electrical receptacle connector according to claim 1, further comprising a connecting arm, wherein the connecting arm connects the left side metal arm and the right side metal arm to form a single structural member, and the insulation body encapsulates the connecting arm.

10. The electrical receptacle connector according to claim 1, further comprising a first light source and a light-guiding structure, wherein the first light source is electrically fixed on the circuit board, the light-guiding structure comprises a first conduction portion and an annular portion connected to the first conduction portion, the first conduction portion has a first light incident surface, the first light incident surface is toward the first light source, the annular portion is disposed close to the front side edge, and the front side edge is located on an inner side of the annular portion in a plug-in connection direction.

11. The electrical receptacle connector according to claim 10, further comprising a second light source, wherein the second light source is electrically fixed on the circuit board, the light-guiding structure comprises a second conduction portion connected to the annular portion, the second conduction portion has a second light incident surface, the second light incident surface is toward the second light source, and the first conduction portion and the second conduction portion are on two opposite sides of the annular portion.

12. The electrical receptacle connector according to claim 10, wherein the first light source and the board fringe connection portion are on two sides of the intermediate portion.
